(19) United States
(12) Patent Application Publication
(10) Pub. No.: US 2021/0093502 A1
(43) Pub. Date: Apr. 1, 2021

(54) SUPPORT PAD WITH ANTI SKID BACKING

(71) Applicant: Vertex Medical, Knoxville, TN (US)

(72) Inventors: Tracy Thompson, Knoxville, TN (US); Fred McBee, Knoxville, TN (US); Chris Doody, Knoxville, TN (US)

(21) Appl. No.: 16/268,978

(22) Filed: Feb. 6, 2019

Related U.S. Application Data
(60) Provisional application No. 62/627,048, filed on Feb. 6, 2018.

(51) Int. Cl. A61G 13/12

(52) U.S. Cl. CPC A61G 13/126

(57) ABSTRACT

A foam pad to support a patient on a patient support structure, the foam pad having a top surface to support the patient's body, and a bottom surface to contact a working surface of the patient support structure, the bottom surface comprising one or more anti-skid backing portions to adhere the bottom surface of the foam pad to the working surface so as to prevent the patient's body from slipping relative to the working surface.

### CROSS REFERENCE TO RELATED APPLICATIONS

This application claims priority from U.S. Provisional Application No. 62/627,048 filed on Feb. 6, 2018.

### FIELD OF INVENTION

The present general inventive concept relates to a foam pad to support a patient on an operating table, bed, chair, or other patient support structure in the medical or patient care field.

### BACKGROUND

It is well-known to provide foam surface covers for operating tables, beds, chairs, or other patient support structures designed to support patients during medical examinations and/or procedures. There remains a need for an easy and secure way to secure foam pads to such patient support structures so that the pad stays in place relative to the table or bed to prevent slippage of the pad relative to the table and to keep the patient in position when the patient is positioned on the patient support structure, for example in the Trendelenburg position.

### BRIEF SUMMARY

Example embodiments of the present general inventive concept provide a foam pad having one or more adhesive (i.e., sticky) backing portions disposed on the underside of the foam pad. The sticky adhesive backing layer can be configured in various ways to achieve the desired results of interacting with and gripping against the working surface of the patient support structure to prevent the pad from slipping on the working surface. In some embodiments, the adhesive material comprises a latex-free material. The adhesive layer can be a pressure sensitive adhesive backing, a double-sided adhesive backing material, an adhesive material strategically applied to one or more portions of the foam pad, such as a spray-on adhesive material or applicator based material configured to work in combination with the foam material and patient support surface to securely support the patient on the support structure during various surgical procedures, including Trendelenburg positioning. A variety of known or later developed types of adhesive materials can be used.

### BRIEF DESCRIPTION OF THE DRAWINGS

The following example embodiments are representative of exemplary techniques and structures designed to carry out the objectives of the present general inventive concept, but the present general inventive concept is not limited to these example embodiments. Moreover, in the accompanying drawings and illustrations, the sizes and relative sizes, shapes, and qualities of lines, entities, and regions may be exaggerated for clarity. A wide variety of additional embodiments will be more readily understood and appreciated through the following detailed description of the exemplary embodiments, with reference to the accompanying drawings in which:

FIG. 1 is a perspective view of a foam pad configured in accordance with an example embodiment of the present general inventive concept;

FIG. 2 is a side view of a foam pad placed on the working surface of a patient support structure to support a patient in the Trendelenburg position according to an example embodiment of the present general inventive concept;

FIG. 3. is a side view of a foam pad placed on the working surface of a patient support structure according to an example embodiment of the present general inventive;

FIG. 4 is a perspective view showing an egg crate foam pad configured in accordance with an example embodiment of the present general inventive concept;

FIG. 5A is a perspective view of the egg crate foam pad of FIG. 4, illustrating an anti-skid material layer disposed on portions of the underside of the foam pad according to an example embodiment of the present general inventive concept;

FIG. 5B is a perspective view the egg crate foam pad of FIG. 5, illustrating removable backings to expose the anti-skid material layer disposed on portions of the underside of the foam pad according to an example embodiment of the present general inventive concept;

FIG. 6A is a perspective view of a foam pad having an anti-skid material layer disposed on a portion of the underside of the foam pad according to an example embodiment of the present general inventive concept;

FIG. 6B is a perspective view of a foam pad having an anti-skid material layer disposed on the underside of the foam pad according to an example embodiment of the present general inventive concept;

FIG. 7 is a perspective view of a foam pad configured having a sloping top surface in accordance with an example embodiment of the present general inventive concept;

FIG. 8A is a perspective view illustrating a foam pad rolled-up in accordance with an example embodiment of the present general inventive concept;

FIG. 8B is a perspective view illustrating a foam pad folded-up in accordance with an example embodiment of the present general inventive concept; and

FIGS. 9A-10B are perspective views illustrating anti-skid material disposed in various locations of the underside of a foam pad according to example embodiments of the present general inventive concept.

### DESCRIPTION OF INVENTIVE CONCEPT

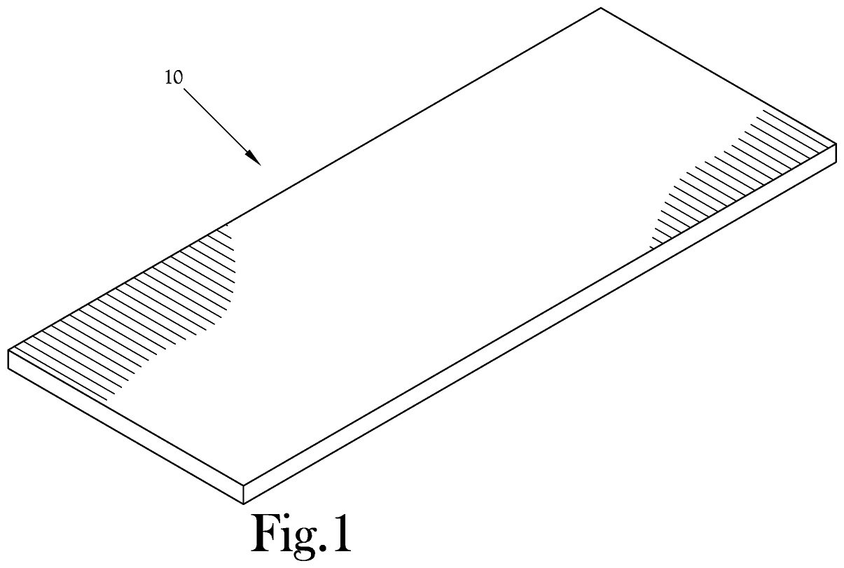

The attached FIGS. 1-10B illustrate various examples of foam pads configured for use in accordance with example embodiments of the present general inventive concept.

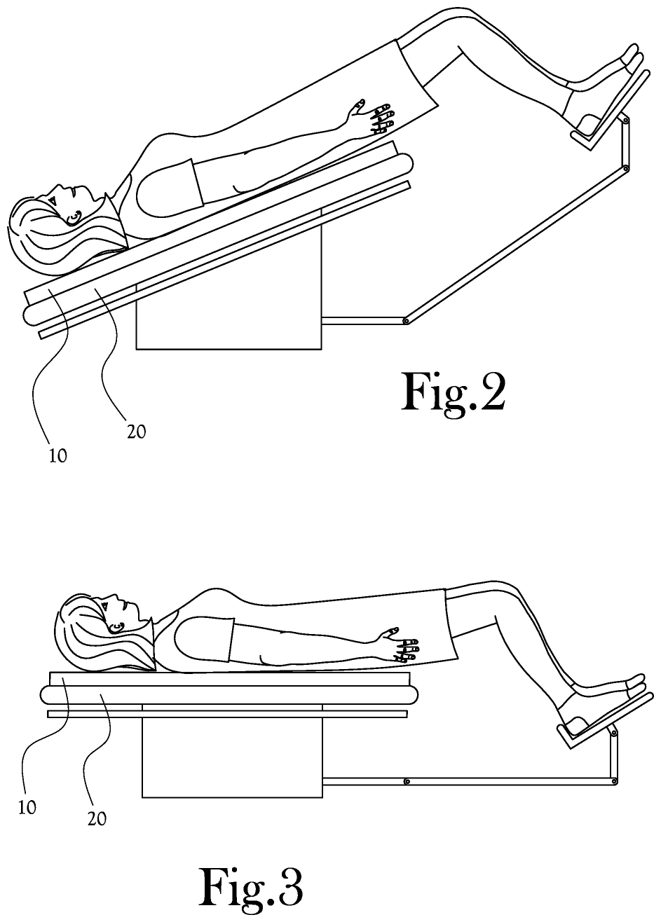

FIG. 1 is a perspective view of a foam pad 10 configured in accordance with an example embodiment of the present general inventive concept. FIG. 2 is a side view of the foam pad 10 placed on the working surface 20 of a patient support structure to support a patient in the Trendelenburg position according to an example embodiment of the present general inventive concept, and FIG. 3 illustrates the patient in a horizontal position. The patient may be placed in variety of other positions and/or angles.

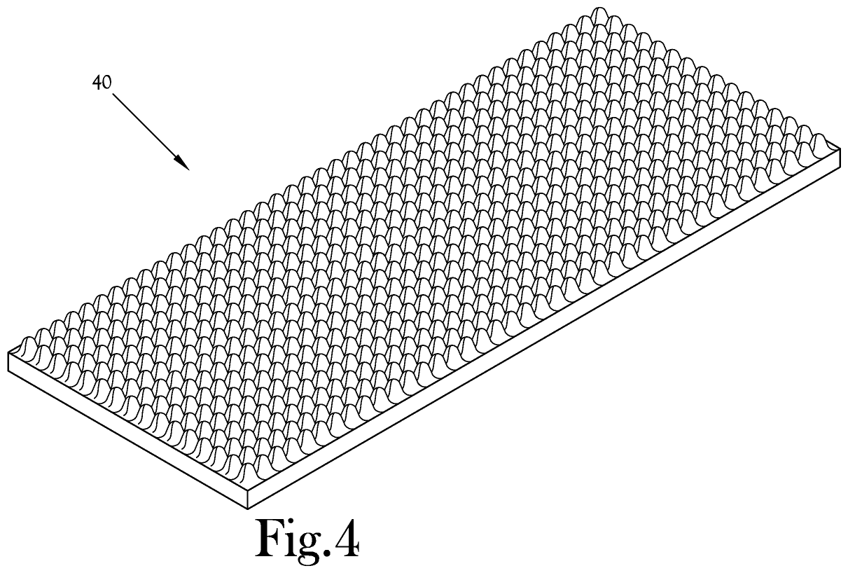

FIG. 4 is a perspective view showing a foam pad 40 constructed of egg-crate foam, but it is understood that the anti-skid backings described herein in accordance with example embodiments of the present general inventive concept can be configured for use on a variety of different foams, including, but not limited to, polyurethane foam, egg-crate foam, air infused polyurethane foam, gel-infused polyurethane foam, or various other types of viscoelastic or non-viscoelastic foam. The foam pad can also take various shapes and sizes depending on the size of the patient support structure, patient, and/or the type of medical procedure.

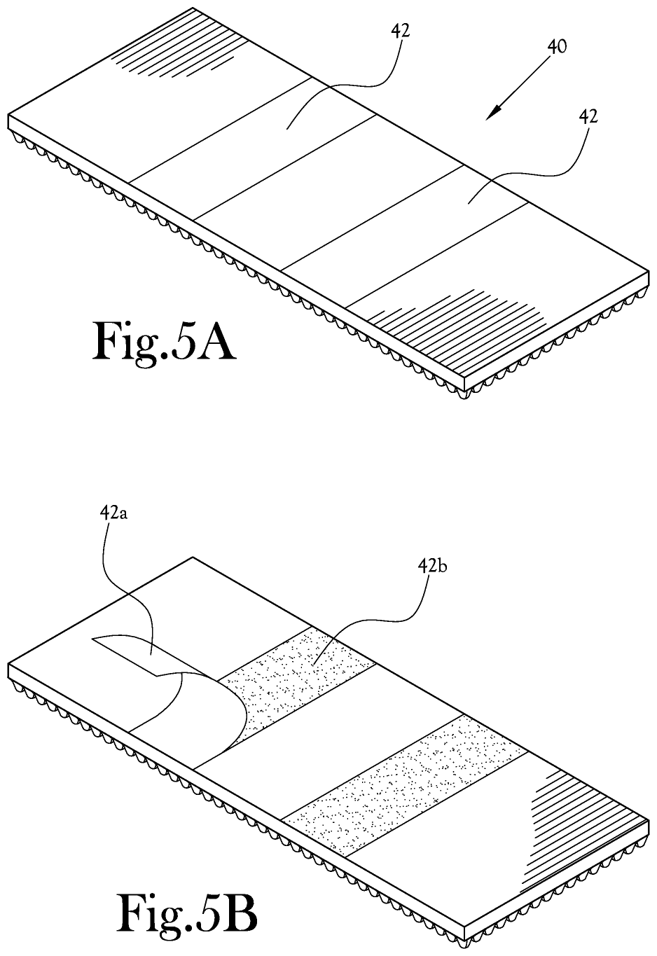

FIG. 5A is a perspective view of the egg crate foam pad of FIG. 4, illustrating an anti-skid material layer 42 disposed on portions of the underside of the foam pad according to an example embodiment of the present general inventive concept. The adhesive layer can be a pressure sensitive adhesive backing, a double-sided adhesive backing material, an adhesive material strategically applied to one or more portions of the foam pad, such as a spray-on adhesive material or applicator based material configured to work in combination with the foam material and patient support surface to securely support the patient on the support structure during various surgical procedures, including Trendelenburg positioning. A variety of known or later developed types of adhesive materials can be used. The adhesive material is specifically configured to permanently adhere to the underside foam material, and releasably adhere to the working surface of the patient positioning structure. The sticky adhesive backing layer can be configured in various ways to achieve the desired results of remaining on the foam material when the foam pad is removed from the table surface, while also interacting with and gripping against the working surface of the patient support structure during use to prevent the pad from slipping on the working surface. In some embodiments, the adhesive material comprises a latex-free material.

FIG. 5B is a perspective view the egg crate foam pad of FIG. 5, illustrating removable backings to expose the anti-skid material layer disposed on portions of the underside of the foam pad according to an example embodiment of the present general inventive concept. These adhesive (i.e., sticky) backing portions can be disposed at various locations, or on the entirety of the underside of the foam pad. In some embodiments the adhesive layer can be configured to provide a first side with a first bonding strength to strongly adhere to the foam material, and a second side with a second bonding strength to provide a reduced bonding strength to the patient support structure, to facilitate removal of the foam pad after use. In this way, the foam pad can be securely mounted on the working surface of the patient support structure, yet be easily removed from the patient support structure after use. Thus, embodiments of the anti-skid or adhesive layer can be configured to permanently stick to the foam material, while also being configured to releasably stick to the patient support structure so as not to leave sticky residue on the patient support structure when the pad is removed.

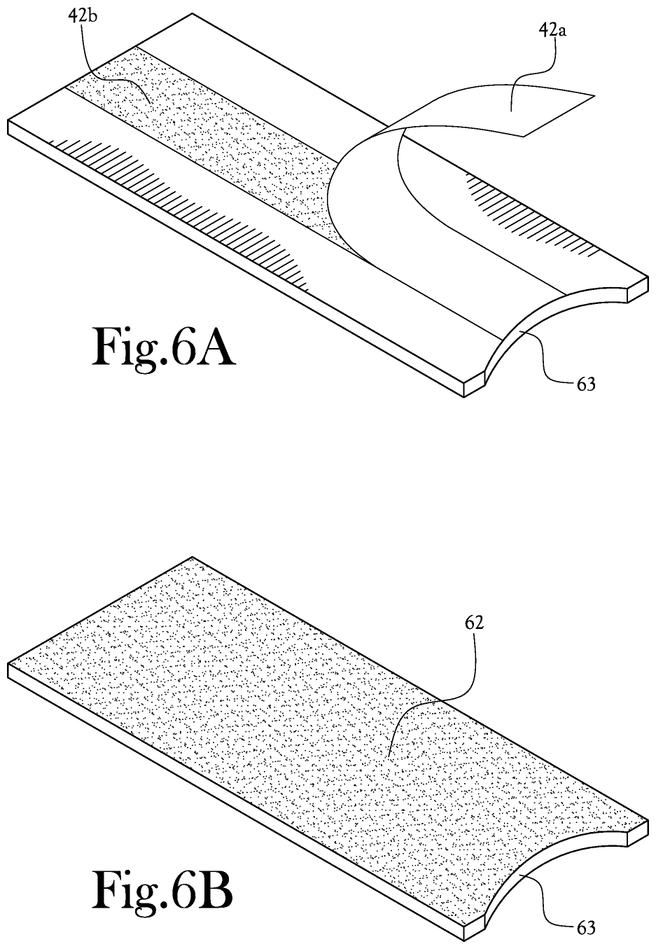

As illustrated in FIG. 5B, the anti-skid backing 42b can be exposed by peeling a cover layer 42a away from an adhesive backing layer 42b to expose the adhesive backing material 42b for adhesion to the patient support structure in a patient care environment such as hospital, clinic, nursing home, or other patient care facility. With this backing layer exposed, the foam pad can be placed on the patient support structure with the adhesive backing contacting the top of the working surface 20 of the patient support structure. The foam pad can be pressed against the top working surface so as to removably, yet firmly grip the working top surface of the table. By way of example and not by way of limitation, the anti-skid layer can be configured in shape and size as one or more strips situated on the underside of the foam pad, or it can be provided on the entirety of the underside of the foam pad as illustrated in FIG. 6B. Various other geometric configurations or locations of the anti-skid portions are contemplated, and the present general inventive concept is not limited to any particular configuration or location for the anti-skid material. It is possible to construct the anti-skid layer 42 with or without a peeling layer 42a.

The anti-skid layer advantageously prevents slippage of the pad relative to the table when the patient is being placed on the pad and/or when the table is tilted into various positions such as the Trendelenburg position. The foam upper layer of the pad also prevents slippage of the patient relative to the pad when the patient is positioned on the table and/or when the table is tilted.

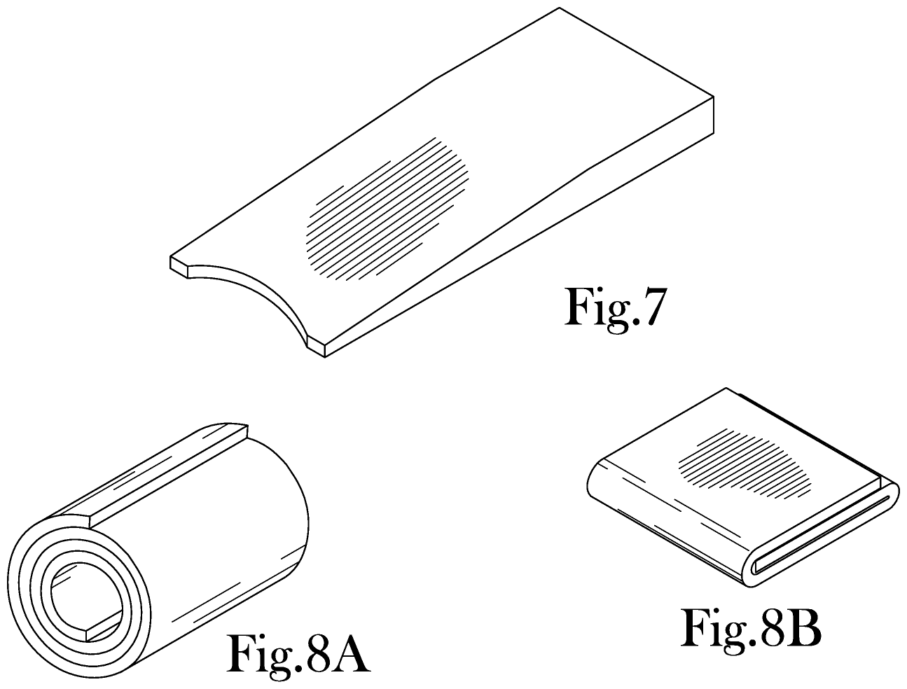

In some embodiments, such as illustrated in FIGS. 6A-6B, the foam pad may include a perineal cut-out 63 to permit access to the patient's perineum when the patient is lying in a supine position on the foam pad. The foam pad may also have a tapered or sloping thickness where the thickness at the foot end is less than the thickness at the head end, as illustrated in FIG. 7.

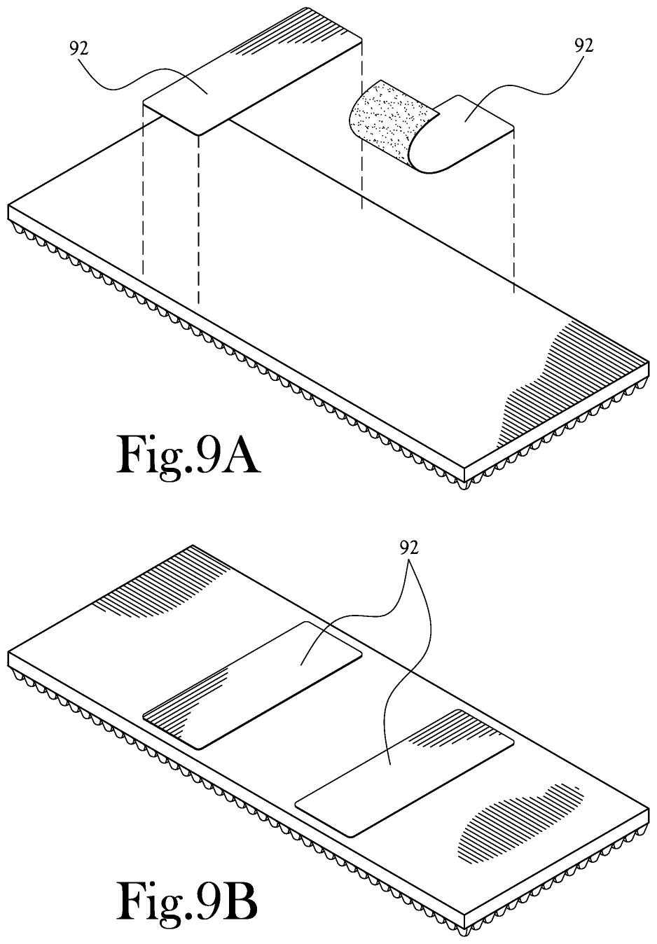

FIG. 8A is a perspective view illustrating a foam pad rolled-up in accordance with an example embodiment of the present general inventive concept, and FIG. 8B is a perspective view illustrating a foam pad folded-up in accordance with an example embodiment of the present general inventive concept. Here, the foam pad can be configured such that the foam has substantially no memory such that when the surgical pad is rolled-up, or folded-up, for example for shipping and/or storage purposes, the surgical pad has a rate of recovery sufficient to return itself to a flat shape in real time upon being unpacked for secure placement on the patient.

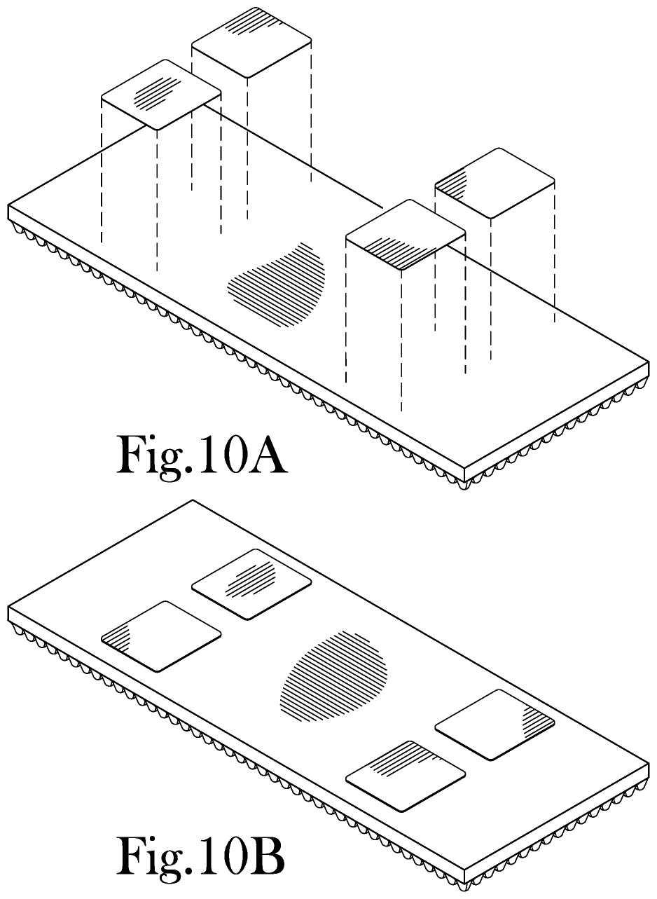

FIGS. 9A-10B are perspective views illustrating anti-skid materials disposed in various locations of the underside of a foam pad according to example embodiments of the present general inventive concept. Here, one or more anti-skid backing portions 92 can be disposed on the underside of the foam pad. In addition to, or in combination with adhesive material, the anti-skid backing portions can take the form of a rubberized anti-skid material 92 affixed to the underside of the foam pad, instead of, or in combination with, a sticky adhesive backing layer. In some embodiments, the anti-skid material can be configured of a latex-free material. The anti-skid material can be a pressure sensitive adhesive backing, a double-sided adhesive backing material, a spray-on adhesive material, a rubberized material, or other known or later developed types of anti-skid materials. In some embodiments the sticky layer can be configured to provide a first side (the underneath surface of 92) with a bonding strength to strongly adhere to the foam material, and a second side (the top surface of 92) with a gripping material configured to grip the bottom surface of the foam pad to the working surface of the patient support structure to prevent the foam pad from sliding relative to the patient support structure when the support structure is tilted or moved. Thus, the foam pad can be easily removed from the patient support structure after use, and while the anti-skid layer sticks to the foam, it is easily removed from the patient support structure.

As illustrated in FIGS. 9A-10B, the anti-skid layer can be located on one or more portions of the underside of the foam pad, or can be provided on the entirety of the underside of the foam pad. The foam pad can be configured using various types of foam material known and used in the medical/patient care industry to support and position a patient on the patient support structure, including, but not limited to, polyurethane foam, egg-crate foam, air infused polyurethane foam, gel-infused polyurethane foam, or various other types of viscoelastic or non-viscoelastic foam.

In some embodiments, the anti-skid backing layer can take the form of rubberized strips or patches. The rubberized strips can be configured to prevent slippage of the pad relative to the table when the patient is being placed on the pad and/or when the table is tilted into various positions such as the Trendelenburg position. The foam upper layer of the pad also prevents slippage of the patient relative to the pad when the patient is positioned on the table and/or when the table is tilted. The strips can be affixed to the pad in a number of different ways, such as by gluing, molding, stapling, sewing, embedding, or various other known or later developed attachment means chosen using sound engineering judgement. By way of example, and not by way of limitation, FIGS. 9A and 9B show an embodiment where 2 rubber strips are used, while FIGS. 10A and 10B show an embodiment where 4 rubber strips are used. Various other numbers/shapes/configurations of anti-skid members may be used without departing from the spirit of the present general inventive concept.

Additional features and embodiments of the present general inventive concept will be set forth in part in the description which follows and, in part, will be obvious from the description, or may be learned by practice of the present general inventive concept.

1. A foam pad to support a patient on a patient support structure, the foam pad having a top surface to support the patient's body, and a bottom surface to contact a working surface of the patient support structure, the bottom surface comprising one or more anti-skid backing portions to adhere the bottom surface of the foam pad to the working surface so as to prevent the patient's body from slipping relative to the working surface.

2. The foam pad of claim 1, wherein the one or more anti-skid backing portions include a cover layer removably attached to the one or more anti-skid backing portions such that when the cover layer is removed, the one or more adhesive backing portions are exposed to fixedly grip a working surface of the patient support structure when the bottom surface is placed on the working surface of patient support surface.

3. (canceled)

4. The foam pad of claim 1, wherein the one or more anti-skid backing portions are configured of one or more of a latex-free material, a pressure sensitive adhesive backing, a double-sided adhesive backing material, a spray-on adhesive material, and an applicator based adhesive material.

5. The foam pad of claim 1, wherein the one or more anti-skid portions are integrally formed with the bottom surface.

6. The foam pad of claim 1, wherein the one or more anti-skid backing portions include one or more rubberized anti-skid strips affixed to the bottom surface of the foam pad.
